(19) United States
(12) Patent Application Publication
(10) Pub. No.: US 2004/0180310 A1
(43) Pub. Date: Sep. 16, 2004

(54) Interactive marker kit

(76) Inventor: Ze Wen Lee, Panchiao (TW)

Correspondence Address: SOFER & HAROUN LLP., 317 MADISON AVENUE, SUITE 910, NEW YORK, NY, 10017, US

(21) Appl. No.: 10/386,905

(22) Filed: Mar. 12, 2003

(51) Int. Cl. G09B 11/00

(52) U.S. Cl. 434/81

(57) ABSTRACT

To this end, the present invention is directed to an interactive marker kit comprised of a case for storing markers. The case has an activity area with the activity area comprised of a marker receptacle for receiving the markers such that when a marker is selected and a base portion of the marker is placed in the marker receptacle, the kit electronically recognizes the marker and provides a response based on the particular marker selected.

### FIELD OF THE INVENTION

The present invention is directed to an interactive marker kit. More specifically, the present invention is directed interactive marker kit that provides voice communications in response to actions taken by the user.

### BACKGROUND OF THE INVENTION

The use of kits to store collections of markers, crayons or other drawing implements is a common method of storing or shipping craft products of this type. Such kits range from sophisticated artists supply kits down to children's toys. The marker kits maintain various features such as holders for the writing implements, cords to keep the writing implements from being lost and other such organizational features.

For example, U.S. Pat. No. 5,360,342, issued to Pardner, is directed to a coloring board with attached crayons. This device provides for a coloring board, having an attached coloring book. Positioned on the top of the board, a series of crayon slots are provided for holding various crayons and are labeled based on their respective color. The crayons are further tethered to the board near their respective crayon slot to help the child identify the color being used and to prevent the crayons from being lost.

Other advancements in marker kits, generally directed at children, include means for producing sounds in response to the contact and movement of the writing implements over a sensor pad.

For example, U.S. Pat. No. 5,5501,601, issued to Todokoro et al. is directed to an educational drawing toy with sound generating functions. This device provides for drawing board having a white drawing area positioned over a contact matrix. As the child draws on the white drawing area the tip of the pin not only draws on the white area, but it also causes a contact with a series of sensors on the matrix below the white pad. As the sensors are contacts the drawing board produces a series of sounds.

Other improvements to marker kits include the detection or absence of markers form their designated holders and other means for altering sounds made by the sensor pad based on the marker used.

For example, U.S. Pat. No. 5,604,517, issued to Filo, is directed to an electronic drawing device. This device maintains a series of drawing instrument holders, each having a drawing instrument detector. Each instrument holder slot and accompanying detector is associated with a particular color drawing instrument. The device also maintains a similar drawing area and sensor matrix as described above with relation to the '601 patent. When a child removes a drawing implement of a particular color from its holder, the detector identifies that its corresponding drawing implement is removed such that the matrix can alter the sounds made based on the various colors used.

However, the prior art writing implement kit systems, are limited in their ability to interact with a user in reciprocal educational communications. Likewise, complicated learning devices which employ writing implements in some fashion employ high cost and complicated circuitry. Therefore, there exists a need to develop an interactive marker kit that not only provides a means for organizing writing implements, but also allows for a relatively wide range of interaction between the user and the kit in terms of learning and testing and, with both results being achieved with uncomplicated circuitry and inexpensive construction.

### SUMMARY OF THE INVENTION

To this end, the present invention is directed to an interactive marker kit comprised of a case for storing markers. The case has an activity area with the activity area comprised of a marker receptacle for receiving the markers such that when a marker is selected and a base portion of the marker is placed in the marker receptacle, the kit electronically recognizes the marker and provides a response based on the particular marker selected.

### BRIEF DESCRIPTION OF THE FIGURES

FIG. 1 illustrates a perspective view of an interactive marker kit in a closed position, in accordance with one embodiment of the present invention;

FIG. 2 illustrates a perspective view of an interactive marker kit in an open position, in accordance with one embodiment of the present invention;

FIG. 3 illustrates a close up perspective view of a marker, in accordance with one embodiment of the present invention;

FIG. 4 illustrates a close up top view of marker base receptacle, in accordance with one embodiment of the present invention;

FIG. 5 illustrates a close up top view of an interaction selector, in accordance with one embodiment of the present invention;

FIG. 6 is a operation flow chart of an interactive marker kit in a learn mode, in accordance with one embodiment of the present invention;

FIG. 7 illustrates a close a perspective view of the interactive marker kit with a marker disposed in the marker base receptacle, in accordance with one embodiment of the present invention; and

FIG. 8 is a operation flow chart of an interactive marker kit in a test mode, in accordance with one embodiment of the present invention.

### DETAILED DESCRIPTION OF THE PREFERRED EMBODIMENTS

The present invention provides for an interactive marker kit 10 having a carrying case 12 and a number of markers 50, contained in case 12 for storage. Markers 50 are configured to interact with case 12 as described below, in response actions taken by the user for the purposes of education and amusement.

As illustrated in FIG. 1, marker kit 10 maintains a case 12, preferably constructed of a durable plastic. Case 12 is provided with an upper and lower portion 12a and 12b respectively such that case 12 is in the standard shape of a briefcase. Latches 14 are provided on lower potion 12b of case 12 so as to secure case 12 into a closed position when not in use. In addition, case 12 is further provided with first and second handle portions 16a and 16b being positioned on case 12 on upper and lower portions 12a and 12b respectively. When in the closed position, as illustrated in FIG. 1, case handles 16a and 16b fold together to form a single handle 16 that can be used to carry case 12 when in transit. Upper and lower portions 12a and 12b of case 12 are further outfitted with matching handle recessions 18 designed to receive the handles when case 12 is open so that the outer surfaces of case 12 can lie flat on a surface being used to support marker kit 10 when it is in use.

As illustrated in FIG. 2, upper and lower portions 12a and 12b of case 12 are folded open, in manner similar to that of a briefcase about hinges 20, allowing the user to work with interactive marker kit 10. Both upper and lower portions 12a and 12b of case 12 are fitted with marker inserts 22a and 22b, designed to hold markers 50 in place during storage and transport. Marker inserts 22 are manufactured as removable inserts to be mounted into the insides of upper and lower portions 12a and 12b, however this is no way intended to limit the scope of the present invention. For example, marker inserts 22 may be molded directly into the inner-sides of case 12 are also within the contemplation of the present invention.

Marker insert 22b maintains substantially the same dimensions of lower portion 12b of case 12 in which it is inserted. Marker insert 22a maintains dimensions smaller than upper portion 12a of case 12 leaving room for an activity area 24. Activity area 24, located on upper portion 12a of case 12 provides a means for users to interact with interactive marker kit 10. Activity area 24 maintains a speaker 100, an interaction selector dial 150 and a marker receptacle 200, described in more detail below.

As illustrated in FIG. 3, marker 50 is comprised of a marker body 52, a cap 54 a base portion 58 and a label region 56. When not in use, markers 50 are configured to be stored in marker inserts 22 in case 12 as described above. When used, markers 50 operate similar to standard felt tip magic markers. Marker body 52 and cap 54 are substantially the same color as the ink contained in the marker so that the color of marker 50 may be readily identified.

It should be noted that the use felt tip marker is simply used to illustrate the preferred embodiments and is no way intended to limit the scope of the present invention. For example, any writing implement making use of similar devices such as marker base 58, capable of interacting with marker kit 10, is within the contemplation of the present invention.

Label region 56 on markers 50 maintain further insignias on marker body 52 such as the names of animals or simple objects. The insignias contained in label region 56 also maintain a picture that matches the named object or animal. In addition, the object or animal depicted in label region 56 may be related to the color of marker 50. For example, in the event that the colors match the insignia in label region 56, a brown marker 50 may contains the word chocolate in label region 56 as well as picture of chocolate bar. Alternatively, the colors of markers 50 may be unrelated to the insignias in label region 56. In such a situation, for example, the black marker 50 may contain the word apple and a corresponding picture of an apple in label region 56.

It should be noted that any number of combinations of insignia in label region 56 with colored markers 50 are possible, and are all within the contemplation of the present invention. For the purposes of example, the colors of markers 50 will be assumed to be unrelated to the insignias depicted in label regions 56.

As illustrated in FIG. 3, markers 50 further maintain a base portion 58. Base portion 58 comprises a ring base 60, having a flat region 62, a rounded region 64 and a hollow center region 66. Also, disposed internally within base portion 50, is an electronic storage means 68 (not pictured) for storing electronic information that corresponds to the characteristics of marker 50.

For example, black marker 50 maintains blank ink, as denoted by its by its black marker body 52 and black cap 54 and also maintains the insignia with the word apple and corresponding illustration of an apple in label region 56. Electronic storage means 68 in base portion 58 electronically stores this information, relating to the color and insignia.

In addition to storing color, and label information regarding region 56, electronic storage means 68 also stores information relating to particular song or musical score. The musical information may either be related to the color, the insignia in label region 56 or it may be entirely unrelated to both. For example, a rose colored marker 50, may store music information for “Ring around the rosy” into electronic storage means 68. Alternatively, a marker which maintains the insignia for a bridge in label region 56 may store “London Bridge” music information into electronic storage means 68.

In addition to various relationships that may exist between the color of markers 50 and the insignias shown in label regions 56 it is also possible to relate the musical information stored in electronic storage means 68 of base portion 58 to the insignias in label region 56 in any number of ways. However, for the purposes of described the preferred embodiments herein, the color of marker 50, the insignia in label region 56 and the music stored in electronic storage means 68 of marker 50 are all unrelated to one another.

It should be noted that additional information can be stored on marker 50 in electronic storage means 68 in numerous variations. Any such information, whether related to one another or not, stored in similar electronic storage means 68 in a similar marker 50 is within the contemplation of the present invention.

As illustrated in FIG. 2, case 12 maintains activity area 24 having a speaker 100, interaction selector dial 150 and marker receptacle 200. Speaker 100 is a standard audio speaker and is configured to play and music or audio commands and responses as required by interactive marker kit 10.

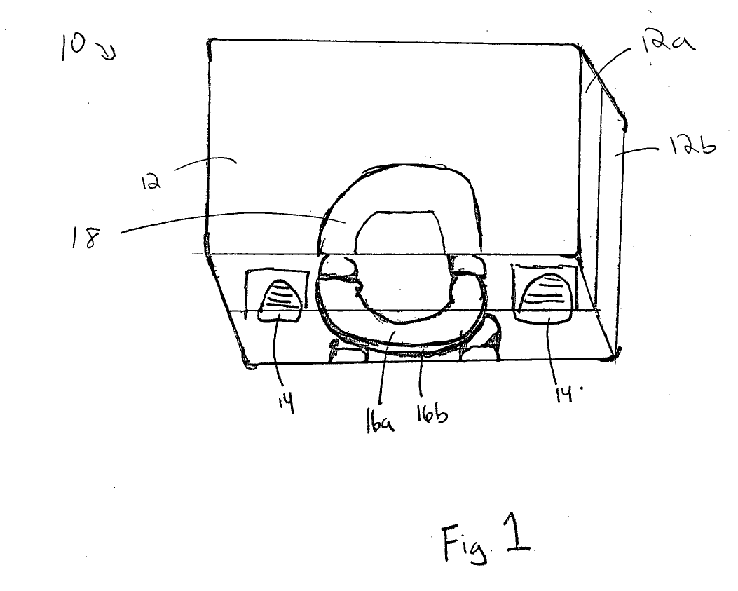

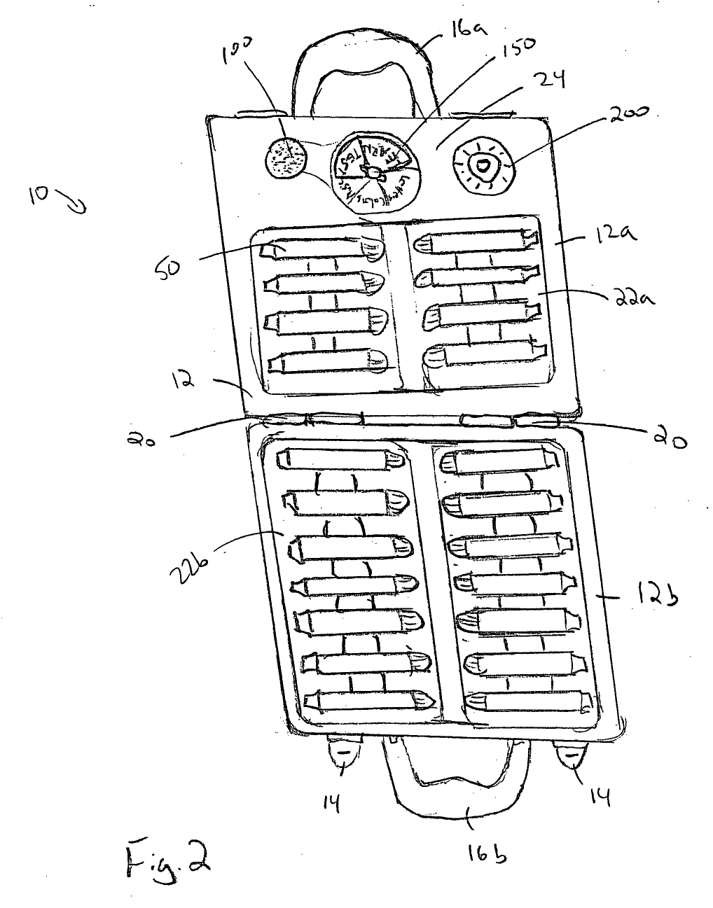

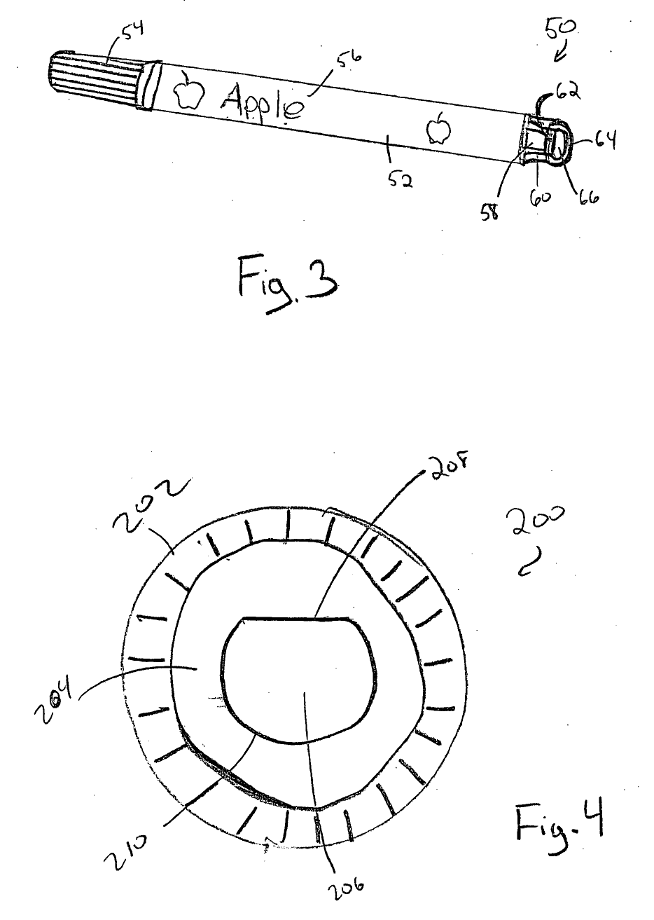

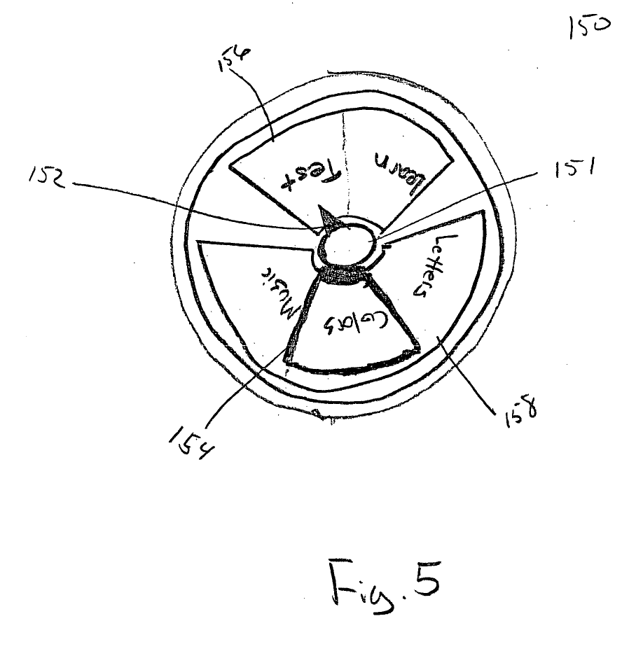

As illustrated in FIG. 4, marker receptacle 200 is substantially the same dimensions as marker base 58. Receptacle 200 is provided with raised region 202 defining the border of receptacle 200. A receiver opening 204 is provided, having a diameter that is conducive to receiving the ring base 60 of base portion 58 of marker 50.

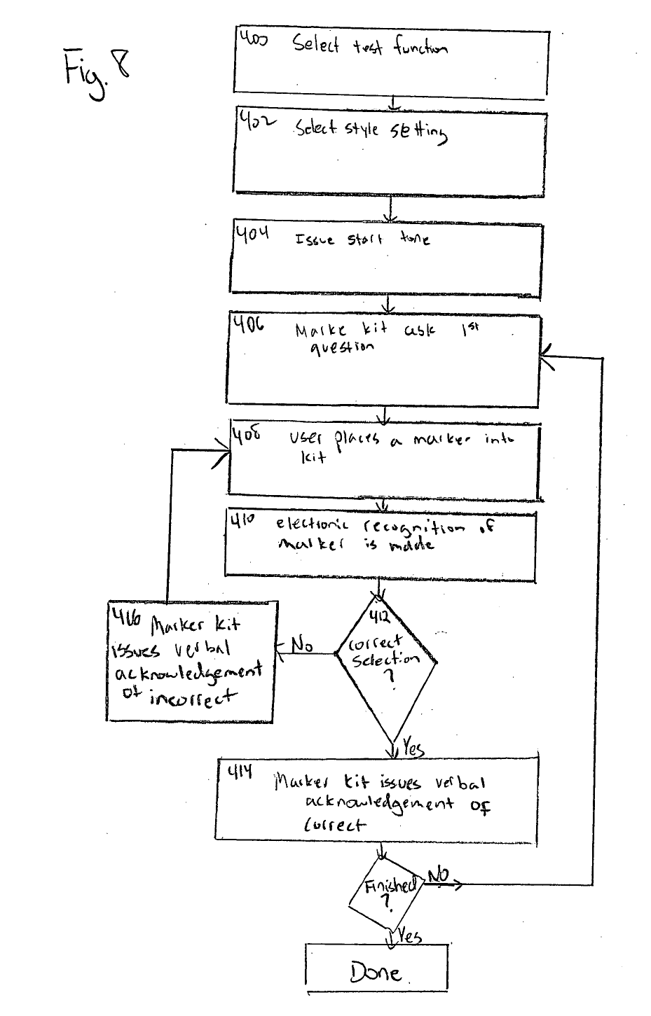

In the center of receiver opening 204 is stem mount 206 having a flat surface 208 and a rounded surface 210. Stem mount 206 is configured to fit inside hollow center region 66 of ring base 60 such that flat surface 208 matches against flat region 62 and round surface 210 matches up against rounded region 64. In this configuration, as illustrated in FIG. 7, markers 50 are configured to be placed into marker receptacle 200 such that step mount 206 supports marker 50 via ring base 60 of base portion 58.

Disposed in marker receptacle 200, an electronic recognition means 212 (not pictured) is positioned internally, and configured to recognize electronic storage means 68 of marker 50. For example, stem mount 206 may be configured to maintain an internally disposed electronic recognition means 212 such that when ring mount 60 of base portion 58 is placed into receiver opening 204, electronic storage means 68 of marker 50 is positioned in close proximity to electronic recognition means 212. In this manner, marker kit 10 may electronically recognize the marker 50 being inserted by the user, and thus be aware of the color, insignia and other label region 56 information on marker 50, as stored in electronic storage means 68.

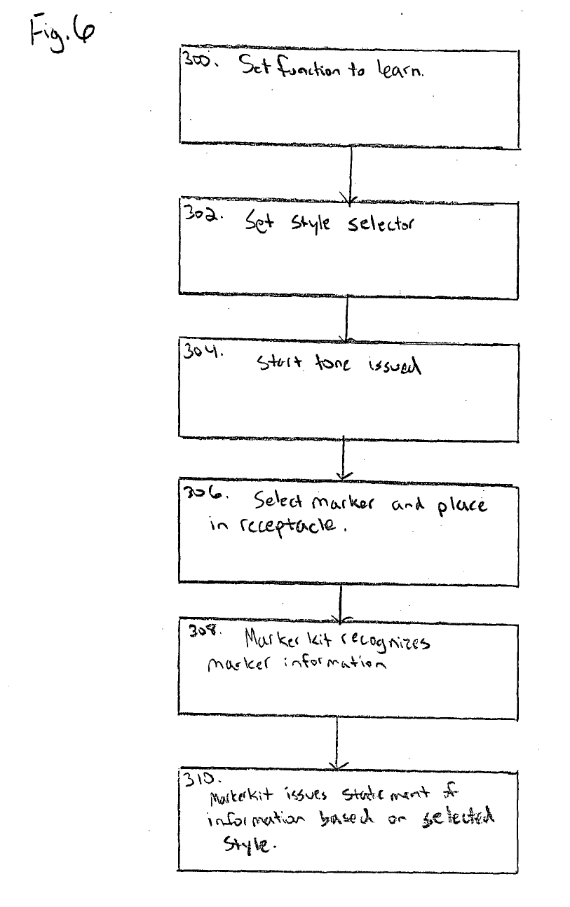

As illustrated in FIG. 5, interaction selector dial 150 is comprised of central hub 151 having two indicators, a function indicator 152 and a style selector 154. Function indicator 152 is placed atop function selection area 156 and configured to be moved between a learn function and a test function. When function indicator 152 is placed over the learn function in function selection area 156, interactive marker kit 10 operates in a learning mode as discussed below. Alternatively, when function indicator 152 is placed over the test function in function selection area 156 (as pictured), interactive marker kit operates in a test mode where kit 10 solicits responses from the user and indicates the correctness or incorrectness of that response.

As illustrated in FIG. 5, style selector 154 is located above a style selection region 158. As illustrated, style selection region 158 maintains a color area, a music area and a letters area. Each of the areas in style selection region 158 refers to the various styles in which the functions, as selected above will operate. For example, when style selector 154 is located over the music area, marker kit 10 with either test or teach musical lessons associated with the material in label region 56 of markers 50. If style selector 154 is located over the letters area, marker kit 10 with either test or teach letter associations with the material in label region 56 of markers 50. Likewise, when style selector 154 is located over the colors area, marker kit 10 with either test or teach color associations with the various colored markers 50.

It should be noted that the described regions in style selection region 158 and function selection region 156 are intended only as possible examples of the function of marker kit 10 and are in no way intended to limit the scope of the present invention. For example, additional functions such as advanced/beginner learning or additional styles such as pictures that utilize similar features to marker kit 10 are within the contemplation of the present invention.

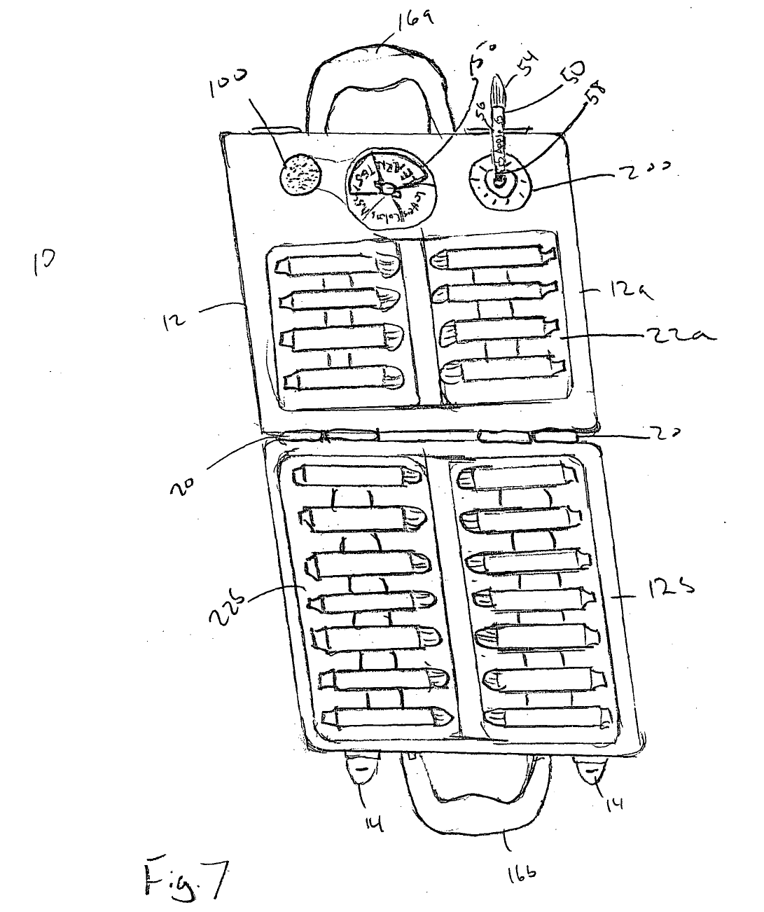

In operation, as illustrated in FIG. 6, a user selects the learn function at step 300 by placing the function indicator 152 over the learn region of function selection area 156. After placing function indicator 152, at step 302, style selector 154 is moved to the colors region on style selection region 158. At step 304, kit 10 issues a start tone from speaker 100 indicating that the user can start at any time.

Next at step 306, a user selects a marker 50 and places marker base 58 into marker receptacle 200. At step 308, electronic recognition means 212 comes into proximity with electronic storage means 68 in base portion 58 of marker 50, as illustrated in FIG. 7. At step 310, kit 10 then recognizes electronic storage means 68 and, in view of the color style being selected by style selector 154, recites the color of inserted maker 50.

It should be noted that a similar operation for learning on marker kit 10 applies regardless of the style selected by style selector 154.

In the alternative test function, as illustrated in FIG. 8, at step 400, function selector 152 is placed over the test region of function selection region 156. Next, at step 402, style selector 154 is moved to the colors region on style selection region 158. At step 404, marker kit 10 issues a start tone from speaker 100 indicating that the user can start at any time.

Next at step 406, based on the selection of the color style, marker kit 10 issues a test command, such as, “please retrieve the black marker.” At step 408, the user selects a marker 50 and places marker base 58 into marker receptacle 200. At Step 410, electronic recognition means 212 comes into proximity with electronic storage means 68 in base portion 58 of marker 50, as illustrated in FIG. 7. At step 412, marker kit 10 then recognizes electronic storage means 68 and determines whether or not the correct selection was made by the user. If so, at step 414 the kit acknowledges the correct selection by the user and issues a verbal congratulation via speaker 100 and then returns to step 406 and continues testing. If the incorrect maker was selected, then, at step 416 kit 10 communicates that the selection was incorrect and requests that a different marker be selected. The process then returns to step 408 and continues until the correct marker is selected.

In an alternative testing arrangement, if a user gets a selection wrong, the process acknowledges such, and returns instead to step 406 and asks for a marker of different color. Likewise, marker kit 10 could be set such that after an incorrect selection, it is first acknowledged, and then returned to step 408, for limited number of tries. If the correct marker 50 is not selected in that number of tries, then the test proceed back to step 406. Any number of variations that utilizes similar basic steps, with a similar marker kit 10 is within the contemplation of the present invention.

It should be noted that a similar operation for testing on marker kit 10 applies regardless of the style selected by style selector 154.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. An interactive marker kit comprising:
a case for storing markers, said case having an activity area; and
a marker receptacle, located in said activity area for receiving said markers such that when a marker is selected and a base portion of said marker is placed in said marker receptacle, said kit electronically recognizes said marker and provides a response based on the particular marker selected.

2. The interactive marker kit as claimed in claim 1, wherein said base portion of said marker further comprises an electronic storage means for electronically storing the information pertaining to said marker.

3. The interactive marker kit as claimed in claim 2, wherein said information pertaining to said marker includes any one of, the color of said marker, label region information and music information.

4. The interactive marker kit as claimed in claim 2, wherein said marker receptacle further comprises an electronic recognition means for electronically communicating with said electronic storage means in said base portion of said marker.

5. The interactive marker kit as claimed in claim 1, wherein said activity region further comprises a speaker.

6. The interactive marker kit as claimed in claim 1, wherein said activity area further comprises an interaction selector dial for placing said interactive marker kit into various modes of operation.

7. The interactive marker kit as claimed in claim 6, wherein said interaction selector dial further comprises a function indicator.

8. The interactive marker kit as claimed in claim 7, wherein said function indicator selects between either a learn function or a test function.

9. The interactive marker kit as claimed in claim 6, wherein said interaction selector dial further comprises a style selector.

10. The interactive marker kit as claimed in claim 9, wherein said style selector selects between any one of a color style, a music style or a letters style.

11. An interactive marker kit comprising:
a case for storing markers, said case having an activity area; and
an interaction selector dial configured to place said interactive marker kit into various modes of operation, said interaction selection dial having a function indicator for selecting between the function options for said marker kit and a style selector for selecting between the style options for said marker kit such that when a marker is placed into said activity area said interactive marker kit responds based on the selected function option and style option.

12. The interactive marker kit as claimed in claim 11, where in said function opinions include a test function and a learn function.

13. The interactive marker kit as claimed in claim 11, wherein said style options include a colors option, a letters option and a music option.

14. The interactive marker kit as claimed in claim 11, wherein said markers further comprising a base portion having an electronic storage means therein for electronically storing information pertaining to said marker.

15. The interactive marker kit as claimed in claim 14, wherein said information pertaining to said marker includes any one of, the color of said marker, label region information and music information.

16. The interactive marker kit as claimed in claim 14, wherein said activity area further comprises a marker receptacle.

17. The interactive marker kit as claimed in claim 16, wherein said marker receptacle further comprises an electronic recognition means for electronically communicating with said electronic storage means in said base portion of said marker.

18. The interactive marker kit as claimed in claim 11, wherein said activity region further comprises a speaker.

19. The interactive marker kit as claimed in claim 15, wherein said color of said marker is related to said label information on said marker.

20. The interactive marker kit as claimed in claim 15, wherein said music information of said marker is related to said label information on said marker.
